(19) United States
(12) Patent Application Publication
(10) Pub. No.: US 2009/0152886 A1
(43) Pub. Date: Jun. 18, 2009

(54) ARMREST CONSOLE BOX FOR VEHICLES

(75) Inventor: Kwang Gi Lee, Gunpo-si, (KR)

Correspondence Address: MORGAN, LEWIS & BOCKIUS LLP (SF), One Market, Spear Street Tower, Suite 2800, San Francisco, CA, 94105, US

(73) Assignee: Hyndai Motor Company, Seoul (KR)

(21) Appl. No.: 12/327,718

(22) Filed: Dec. 3, 2008

(30) Foreign Application Priority Data
Dec. 12, 2007 (KR) 10-2007-0129291

(51) Int. Cl. B60R 7/04; B60N 2/46

(52) U.S. Cl. 296/37.8; 224/486; 224/539

(57) ABSTRACT

An armrest console box for a vehicle, having a button, a button housing moved horizontally by the button, a coil spring elastically biasing a rear portion of the button housing forwards, a knob protruding from a predetermined portion of the button housing, a locking member rotated by the knob, and a locking projection of a main body hooked onto a hook provided on a lower end portion of the locking member, may include: an insertion hole formed in the knob in such a way as to vertically pass through the knob; and an insertion protrusion protruding horizontally from an outer surface of an upper end portion of the locking member, and then bent perpendicularly at an end, the bent end being inserted into the insertion hole.

### CROSS-REFERENCE TO RELATED APPLICATION

The present application claims priority to Korean Patent Application Number 10-2007-0129291 filed Dec. 12, 2007, the entire contents of which application is incorporated herein for all purposes by this reference.

### BACKGROUND OF THE INVENTION

1. Field of the Invention

The present invention relates generally to an armrest console box for vehicles and, more particularly, to an armrest console box for vehicles, which is constructed so that the lid of the armrest console box installed in a front or rear seat does not unexpectedly open in the event of a vehicular collision, thus ensuring the safety of passengers, and preventing unnecessary noise from being generated when the lid of the armrest console box is opened or closed.

2. Description of Related Art

Generally, an armrest console box is installed in the middle of a front or rear seat of a vehicle, thus serving as an armrest so that a passenger assumes a more comfortable posture, and storing personal belongings of passengers.

A lid is connected to the armrest console box via a hinge. A locking device is provided between the lid and the main body of the console box. When a user manipulates the locking device, the lid rotates around the hinge, thus opening or closing the main body of the console box. Further, the locking device is constructed to lock and unlock the lid to and from the main body of the console box. Normally, the lid is locked to the main body of the console box, closing the main body. As the locking device is manipulated by a user, the lid is released from the main body of the console box, so that the main body of the console box is opened. In order to easily manipulate the lid while the user's arm is rested on the console box, a manipulating means such as a button is mounted to the front portion of the lid.

FIGS. 1 and 2 illustrate a conventional locking structure of an armrest console box for vehicles.

As shown in FIGS. 1 and 2, the conventional locking structure of the armrest console box for vehicles is constructed so that a button housing is elastically biased by a coil spring 14 provided on the rear portion of the button housing, and a knob 13 protruding from the lower end portion of the button housing is not in contact with a locking portion 19 when a button 11 is not being pressed by a user. Further, since a hook 16 provided on the lower end portion of the locking portion 19 engages with a locking projection 18 of a main body of the console box, the lid is locked to the main body of the console box and thereby the main body does not unexpectedly open.

Further, a torsion spring 17 is inserted into the central portion 15 of the locking portion 19, so that the engagement of the locking portion 19 with the locking projection of the main body is maintained by the rotating force of the torsion spring 17.

Meanwhile, when the user presses the button 11 in a horizontal direction H, the button housing compresses the coil spring 14 and moves horizontally backwards, and the knob 13 protruding from the lower end portion of the button housing pushes the upper end portion of the locking portion 19. When the upper end portion of the locking portion 19 is pushed by the knob 13, the locking portion 19 rotates around the central portion 15 into which the torsion spring 17 is inserted, and thereby the hook 16 provided on the lower end portion of the locking portion 19 is released from the locking projection 18 of the main body. As such, when the hook 16 of the locking portion 19 is released from the locking projection 18 of the main body, the lid is unlocked and released from the main body of the console box, so that the lid is opened and thereby the main body of the console box opens.

However, the conventional locking structure of the armrest console box for vehicles constructed as described above has the following problems.

When sudden accelerating force is applied in a button manipulating direction, as in the event of a vehicular collision, the button housing is pushed forwards by inertia due to the acceleration of a vehicle even though a user has not pressed the button. Thereby, the knob of the button housing pushes the upper end portion of the locking portion, so that the hook of the locking portion disengages from the locking projection of the main body, and the lid may undesirably open. This does not satisfy a regulation stating that the lid of the armrest console box must not unexpectedly open so as to protect passengers in the event of vehicular collision, and threatens the safety of the passengers.

Further, when a user pushes the button so as to open the lid, the knob of the button housing and the locking portion which are separated from each other collide with each other, thus generating unnecessary noise.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY OF THE INVENTION

Various aspects of the present invention are directed to provide an armrest console box for vehicles, which prevents a lid of the armrest console box from unexpectedly opening even in the event of a vehicular collision.

In an aspect of the present invention, an armrest console box for a vehicle, having a button, a button housing moved horizontally by the button, a coil spring elastically biasing a rear portion of the button housing forwards, a knob protruding from a predetermined portion of the button housing, a locking member rotated by the knob, and a locking projection of a main body hooked onto a hook provided on a lower end portion of the locking member, may include an insertion hole formed in the knob in such a way as to vertically pass through the knob, and/or an insertion protrusion protruding horizontally from an outer surface of an upper end portion of the locking member, and then bent perpendicularly at an end, the bent end being inserted into the insertion hole.

The end of the insertion protrusion inserted into the insertion hole may maintain a state of insertion before and after the button housing moves in a horizontal direction.

The locking member may be biased toward the hook by a torsion spring,

In another aspect of the present invention, an armrest console box for a vehicle, may include a button housing integrally formed with a button and configured to be movable by the button, a first elastic member biasing the button housing forwards, a locking member including a center portion rotatably coupled to the armrest console box, one end portion integrally engaged with the button housing, and the other end portion having a hook member, and/or a second elastic member pivotally biasing the other end portion of the locking member to a locking projection of a main body.

One end portion of the first elastic member may be engaged with a stationary member.

The stationary member may be the center portion of the locking member.

The one end portion of the locking member may be integrally engaged with a knob formed at the button housing.

The knob may be formed with an insertion hole and the one end portion of the locking member is integrally engaged with the insertion hole of the knob. The knob may protrude from an outer surface of the button housing with a predetermined distance to receive the one end portion of the locking member.

An insertion protrusion may protrude from an outer surface of the one end portion of the locking member and extends long sufficiently enough to keep an end of the insertion protrusion inserted into the insertion hole in a state of insertion before and after the button housing moves.

The knob may protrude from an outer surface of the button housing with a predetermined distance in a vertical direction against a movement direction of the button housing and then bent in a horizontal direction. An insertion protrusion may protrude in movement direction of the button housing from an outer surface of the one end portion of the locking member, and then bent perpendicularly at an end thereof, the bent end being inserted into the insertion hole.

The hook member may include a hook and the locking projection of the main body is hooked onto the hook of the locking member.

The first elastic member may be a coil spring.

The second elastic member may be a torsion spring.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a perspective view illustrating important parts of a locking structure of a conventional armrest console box for vehicles.

FIG. 2 is a sectional view illustrating the operation of the locking structure of the conventional armrest console box for vehicles.

FIG. 3 is a perspective view illustrating an exemplary locking structure of an armrest console box for vehicles according to the present invention.

FIG. 4 is a sectional view illustrating the locking structure of the armrest console box for vehicles according to the present invention.

FIG. 5 is a perspective view illustrating an exemplary locking member of the armrest console box for vehicles according to the present invention.

FIG. 6 is a perspective view illustrating an exemplary button housing of the armrest console box for vehicles according to the present invention.

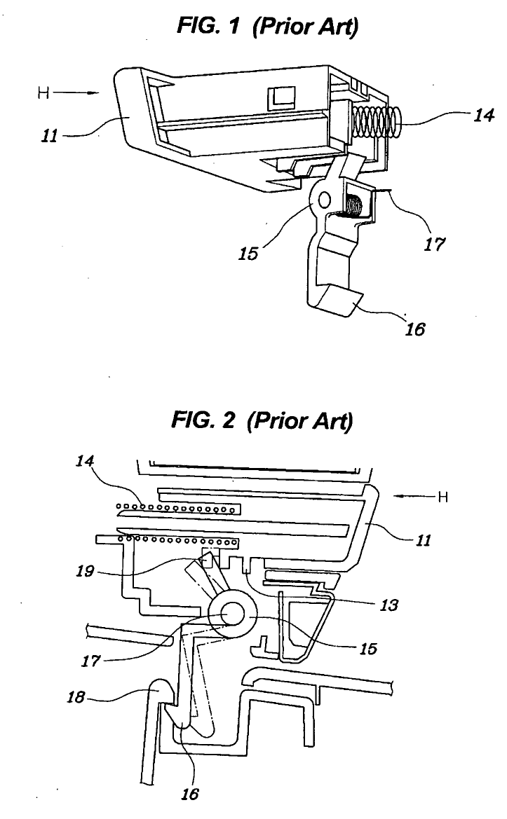

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

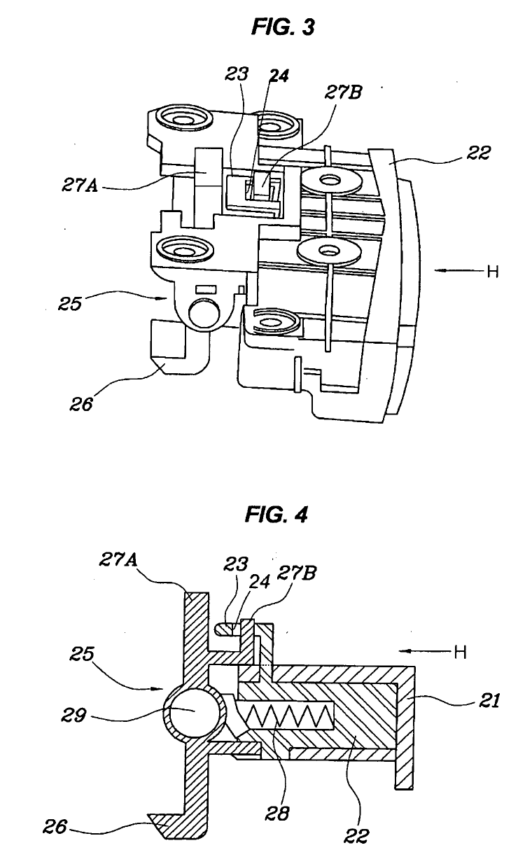

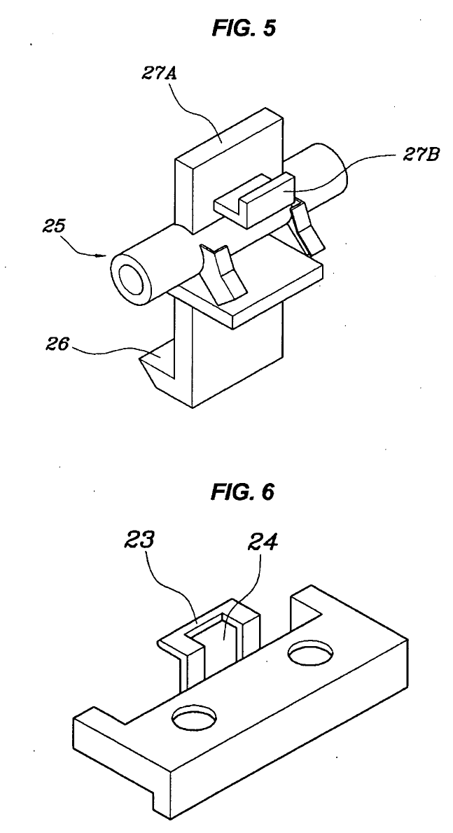

FIGS. 3 and 4 illustrate a locking structure of an armrest console box for vehicles according to various embodiments of the present invention, and FIGS. 5 and 6 illustrate a locking member and a button housing of the armrest console box for vehicles according to various embodiments of the present invention, respectively.

According to various embodiments of the present invention, the locking structure includes a button 21, a button housing 22 which is movable horizontally by the button 21, a coil spring 28 which elastically biases the rear portion of the button housing 22, a knob 23 which protrudes from one end of the button housing 22, a locking member 25 which is rotatably moved by the knob 23, and a locking projection of a main body which engages with a hook 26 provided on the lower end portion of the locking member 25.

Unlike the prior art, the armrest console box for vehicles according to various embodiments of the present invention has an insertion hole 24 which is formed in the knob 23 and vertically passes through the knob 23, as shown in FIGS. 3,4 and 6.

An insertion protrusion 27B protruding from the outer surface of the upper end portion 27A of the locking member 25 is inserted into the insertion hole 24.

Here, the insertion protrusion 27B protrudes horizontally from the outer surface of the upper end portion 27A of the locking member 25 and then is bent perpendicularly, so that the bent end of the insertion protrusion 27B is inserted into the insertion hole 24.

Thus, in the locking structure of the armrest console box for vehicles according to various embodiments of the present invention, the knob 23 and the locking member 25 always maintain a linked state in a normal state. Thus, when the button housing 22 is moved backwards to the direction of H, the upper end portion 27A of the locking member 25 is rotated counterclockwise by the knob 23, in FIG. 4. Thereby, the hook 26 of the locking member 25 is released from the locking projection of the main body.

In contrast, when the button housing 22 is moved forwards, the insertion protrusion 27B of the locking member 25 is rotated clockwise by the knob 23, in FIG. 4, so that the hook 26 of the locking member 25 engages with the locking projection of the main body.

One end of the coil spring 28 may be engaged with a stationary member and the other end thereof may be engaged with the button housing 22. In various embodiments of the present invention, the one end of the coil spring 28 may be engaged with the center portion of the locking member 25.

The locking structure of the armrest console box for vehicles according to various embodiments of the present invention constructed as described above is operated as follows.

When a user does not press the button 21, the button housing 22 is elastically biased outwards by a coil spring 28 which is located at the rear portion of the button housing 22, and the insertion protrusion 27B of the locking member 25 is inserted into the insertion hole 24 formed in the knob 23.

Further, since the hook 26 provided on the lower end portion of the locking member 25 is hooked onto the locking projection of the main body of the console box, the lid is locked to the main body of the console box and therefore will not undesirably open.

Further, in various embodiments of the present invention a torsion spring 29 may be inserted into the central portion of the locking member 25, so that the engagement of the locking member 25 with the locking projection of the main body is maintained by the rotating force of the torsion spring 29 in the normal state.

Now, when a user presses the button 21 in a horizontal direction, the button housing 22 compresses the coil spring 28 and moves backwards in a horizontal direction, and the knob 23 of the button housing 22 pushes the upper end portion 27A of the locking member 25.

As such, when the upper end portion 27A of the locking member 25 is pushed by the knob 23, the locking member 25 rotates in the counterclockwise in the drawing around the central portion into which the torsion spring 29 is inserted, thereby dislodging the hook 26 provided on the lower end portion of the locking member 25 from the locking projection of the main body. As such, when the hook 26 of the locking member 25 is disengaged from the locking projection of the main body, the lid is released from the main body of the console box, so that the lid opens and the main body of the console box is exposed. However the insertion protrusion 27B and the knob 23 are maintained integrally engaged.

Afterwards, when the lid of the console box is closed, the button housing 22 is moved forwards by the elastic restoring force of the compressed coil spring 28, and the knob 23 pulls the insertion protrusion 27B of the locking member 25 forwards from the insertion hole 24. As such, when the insertion protrusion 27B of the locking member 25 is pulled forwards by the knob 23, the locking member 25 rotates in the clockwise direction in the drawing around the central portion into which the torsion spring 29 is inserted, and thereby the hook 26 provided on the lower end portion of the locking member 25 again becomes engaged with the locking projection of the main body. As such, when the hook 26 of the locking member 25 engages with the locking projection of the main body, the engagement of the main body of the console box with the lid is maintained, thus preventing the lid from unexpectedly opening relative to the main body of the console box.

Particularly, in the armrest console box for vehicles according to various embodiments of the present invention constructed as described above, in the event of a vehicular collision, accelerating force is applied to the button housing 22, so that the button housing 22 is pushed backwards and thereafter is moved forwards by the coil spring 28.

In this case, since the knob 23 and the locking member 25 are linked to each other, the locking member 25 is also rotated in one direction by the knob 23 when the button housing 22 is pushed backwards, so that the hook 26 could be temporarily separated from the locking projection of the main body. However, immediately, the button housing 22 is moved forwards by the coil spring 28. At this time, the locking member 25 linked to the knob 23 is rotated in the opposite direction, so that the hook 26 is hooked onto the locking projection of the main body, and thereby the lid does not open away from the main body of the console box.

Further, the knob 23 and the locking member 25 always are engaged with each other while maintaining the linked state. Thus, even if a user presses the button 21 to open the lid, unnecessary noise is not generated by friction occurring between the knob 23 and the locking member 25.

As described above, in various aspects the present invention provides an armrest console box for vehicles, which prevent a lid from becoming undesirably released from a main body of the console box and opening in the event of a vehicular collision, thus satisfying a safety regulation and ensuring the safety of passengers.

Further, the present invention, an another aspect, provides an armrest console box for vehicles which prevents unnecessary noise generated by friction between a knob and a locking member even when a user pushes a button so as to open a lid, thus increasing the comfort of passengers.

For convenience in explanation and accurate definition in the appended claims, the terms “upper”, “lower”, and “rear” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An armrest console box for a vehicle, comprising:
a button housing integrally formed with a button and configured to be movable by the button;
a first elastic member biasing the button housing forwards;
a locking member comprising a center portion rotatably coupled to the armrest console box, one end portion integrally engaged with the button housing, and the other end portion having a hook member; and
a second elastic member pivotally biasing the other end portion of the locking member to a locking projection of a main body.

2. The armrest console box for the vehicle as set forth in claim 1, wherein one end portion of the first elastic member is engaged with a stationary member.

3. The armrest console box for the vehicle as set forth in claim 2, wherein the stationary member is the center portion of the locking member.

4. The armrest console box for the vehicle as set forth in claim 1, wherein the one end portion of the locking member is integrally engaged with a knob formed at the button housing.

5. The armrest console box for the vehicle as set forth in claim 4, wherein the knob is formed with an insertion hole and the one end portion of the locking member is integrally engaged with the insertion hole of the knob.

6. The armrest console box for the vehicle as set forth in claim 5, wherein the knob protrudes from an outer surface of the button housing with a predetermined distance to receive the one end portion of the locking member.

7. The armrest console box for the vehicle as set forth in claim 4, wherein an insertion protrusion protrudes from an outer surface of the one end portion of the locking member and extends long sufficiently enough to keep an end of the insertion protrusion inserted into the insertion hole in a state of insertion before and after the button housing moves.

8. The armrest console box for the vehicle as set forth in claim 4, wherein the knob protrudes from an outer surface of the button housing with a predetermined distance in a vertical direction against a movement direction of the button housing and then bent in a horizontal direction.

9. The armrest console box for the vehicle as set forth in claim 8, wherein an insertion protrusion protrudes in movement direction of the button housing from an outer surface of the one end portion of the locking member, and then bent perpendicularly at an end thereof, the bent end being inserted into the insertion hole.

10. The armrest console box for the vehicle as set forth in claim 1, the hook member includes a hook and the locking projection of the main body is hooked onto the hook of the locking member.

11. The armrest console box for the vehicle as set forth in claim 1, the first elastic member is a coil spring.

12. The armrest console box for the vehicle as set forth in claim 1, the second elastic member is a torsion spring.

13. A passenger vehicle comprising the armrest console box as set forth in claim 1.

14. An armrest console box for a vehicle, having a button, a button housing moved horizontally by the button, a coil spring elastically biasing a rear portion of the button housing forwards, a knob protruding from a predetermined portion of the button housing, a locking member rotated by the knob, and a locking projection of a main body hooked onto a hook provided on a lower end portion of the locking member, the armrest console box comprising:
an insertion hole formed in the knob in such a way as to vertically pass through the knob; and
an insertion protrusion protruding horizontally from an outer surface of an upper end portion of the locking member, and then bent perpendicularly at an end, the bent end being inserted into the insertion hole.

15. The armrest console box as set forth in claim 14, wherein the end of the insertion protrusion inserted into the insertion hole maintains a state of insertion before and after the button housing moves in a horizontal direction.

16. The armrest console box as set forth in claim 14, wherein the locking member is biased toward the hook by a torsion spring.

17. A passenger vehicle comprising the armrest console box as set forth in claim 14.
